(19) United States
(12) Patent Application Publication
(10) Pub. No.: US 2026/0197400 A1
(43) Pub. Date: Jul. 9, 2026

(54) SYSTEM AND METHOD TO PROMPT SERVICE TARGETS FOR DEFERRABLE CONTACTS

(71) Applicant: NICE LTD., Ra'anana (IL)

(72) Inventors: Vaibhav CHOBE, Pune (IN); Niranjan BAGADE, Kothrud (IN); Kanchan VASNANI, Indore (IN)

(21) Appl. No.: 19/009,566

(22) Filed: Jan. 3, 2025

(51) Int. Cl. H04M 3/523; G06Q 10/1093; H04M 3/51

(52) U.S. Cl. CPC H04M 3/5232; G06Q 10/1093; H04M 3/5141

(57) ABSTRACT

A server is configured to, over a first period of time: receive a first set of deferrable contacts; automatically distribute the deferrable contacts to agents for resolution via the agent computing devices; measuring a respective time required for each resolution; and computing an average of the respective required times. The server is also configured to, continuously, in real time: receive a second set of deferrable contacts; based on the average of the respective required times, compute a total required time to resolve the second set of deferrable contacts; with the GUI: display the total required time; receive an approval; automatically generate a required staffing; automatically generate an agent schedule; and with the GUI, publish the agent schedule to the agents.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The subject matter described herein relates to devices, systems, and methods for managing deferrable contacts in a contact center. This deferrable contact staffing forecasting system has particular but not exclusive utility for scheduling agent time in a contact center.

### BACKGROUND

Predicting correct staffing requirements is essential for the success of a contact center's operation, along with meeting its key performance indicators (KPIs). Unfortunately, setting realistic and achievable KPIs by workforce management (WFM) supervisors is an art which comes through experience. In WFM, service targets such as service levels, wait time, etc., defined during the generation of a staffing plan, are used to ensure that any generated agent schedules adhere to the targets and thus contribute to achievement of the KPIs.

In order to achieve service targets, forecasters and WFM supervisors typically have to remember historical data, such as how long it takes to answer different contact types. However, if the service targets are entered incorrectly, the staffing plans and hence the agent schedules may be negatively affected. Eventually, the actual targets achieved can differ significantly from the expected ones. Thus, WFM supervisors have to rely on their experience with the contact center.

Unlike voice calls or direct messaging, which are typically answered in real time, deferrable contacts such as email, voicemail, and social media contacts may be handled asynchronously (e.g., answered sometime after they are received, e.g., within one business day). However, it is not always clear how much agent time will be required to address these deferrable contacts within a specified time window. It is therefore necessary for the staffing plan and agent schedules to accurately reflect the need and ability to address pending deferrable contacts within the specified time window. A need therefore exists for improved WFM tools that address these and other concerns.

The information included in this Background section of the specification, including any references cited herein and any description or discussion thereof, is included for technical reference purposes only and is not to be regarded as subject matter by which the scope of the disclosure is to be bound.

### SUMMARY

Disclosed is a deferrable contact staffing forecasting system and methods. Deferrable contacts include email, voice mail, messaging, social media, and other asynchronous contacts. Historical data is used to identify service targets (e.g., allotted agent time) for pending deferrable contacts, and this information is used to prompt the WFM supervisor, to help them make informed decisions confidently on the service level agreements (SLAs) to be entered at the time of generating the staffing requirements, so that the SLAs can be met and the deferrable contacts more efficiently and accurately addressed.

Average times required to address each contact type are calculated from the historical data. These averages can then be used to calculate the estimated hours needed to handle each contact type, based on the historical data for each deferred contact.

Service targets related to simultaneous handling of contacts are set by the WFM supervisor, with the averages obtained above being used to proportionally increase the agent time requirement for each contact type. For example, if an average of 2 hours is required for handling one email contact, and if the simultaneous handling value is set to 2 by the supervisor for this contact type, then the number of necessary agent hours proposed by the system would be 4 for that contact type. Once the supervisor confirms these service targets, the system defined herein may also automatically generate the agent schedules.

The deferrable contact staffing forecasting system disclosed herein has particular, but not exclusive, utility for projecting staffing needs in a contact center.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system adapted to automatically manage deferrable contacts in a contact center. The system includes a workforce management server having a processor and a non-transitory computer readable medium operably coupled thereto, the server being in electronic communication with a manager computing device and a plurality of agent computing devices. The processor may include: an intraday manager service, a scheduler service, a forecaster service, and a graphical user interface (GUI), the server being in electronic communication with an intraday manager database, the computer readable medium may include a plurality of instructions stored in association therewith that are accessible to, and executable by, the processor, to perform operations. The operations include: with the workforce management server, over a first period of time: receiving a first plurality of deferrable contacts; automatically distributing the deferrable contacts of the first plurality of deferrable contacts to a plurality of agents for resolution via the plurality of agent computing devices; measuring a respective time required for each resolution; computing an average of the respective required times. The operations also include, continuously, in real time, with the workforce management server: receiving a second plurality of deferrable contacts; based on the average of the respective required times, computing a total required time to resolve all of the deferrable contacts of the second plurality of deferrable contacts; with the GUI: displaying the total required time to the manager computing device; receiving an approval from the manager computing device. The operations also include, with the intraday manager service, automatically generating a required staffing; with the scheduler service, the required staffing and the scheduling rules database, automatically generating an agent schedule; and with the GUI, publishing the agent schedule to the plurality of agent computing devices. Other embodiments of this aspect include corresponding computer systems, apparatus, and computer programs recorded on one or more computer storage devices, each configured to perform the actions of the methods.

Implementations may include one or more of the following features. In some embodiments, the first plurality of deferrable contacts and the second plurality of deferrable contacts are of a plurality of contact types. In some embodiments, the plurality of contact types may include at least two of email contacts, voicemail contacts, social media contacts, or other contacts. In some embodiments, the respective required time for each resolution depends on a contact type of the respective deferrable contact, where the average of the respective times may include a separate average for each contact type. In some embodiments, each agent computing device of the plurality of agent computing devices is associated with an agent of the plurality of agents, where the agent schedule may include a separate schedule for each agent of the plurality of agents, and where the separate schedule for each agent is based on a skill of the respective agent with regard to at least one contact type of the plurality of contact types. In some embodiments, displaying the total required time to the manager computing device involves first receiving a manager estimate of the total required time. In some embodiments, displaying the total required time to the manager computing device includes generating and displaying a natural language output related to the total required time. In some embodiments, generating and displaying the natural language output involves: sending a prompt to a large language model (LLM); receiving a natural language output from the LLM; and displaying the natural language output. In some embodiments, the instructions further may include automatically distributing the deferrable contacts of the second plurality of contacts to the plurality of agents for resolution via the plurality of agent computing devices. Implementations of the described techniques may include hardware, a method or process, or computer software on a computer-accessible medium.

One general aspect includes a method to manage deferrable contacts in a contact center. The method includes, with a workforce management server having a processor and a non-transitory computer readable medium operably coupled thereto, the server being in electronic communication with a manager computing device and a plurality of agent computing devices, the processor may include an intraday manager service, a scheduler service, a forecaster service, and a graphical user interface (GUI), the server being in electronic communication with a scheduling rules database, the computer readable medium may include a plurality of instructions stored in association therewith that are accessible to, and executable by, the processor, performing operations which may include: with the workforce management server, over a first period of time: receiving a first plurality of deferrable contacts; automatically distributing the deferrable contacts of the first plurality of deferrable contacts to a plurality of agents for resolution via the plurality of agent computing devices; measuring a respective time required for each resolution; computing an average of the respective required times. The method also includes continuously, in real time, with the workforce management server: receiving a second plurality of deferrable contacts; based on the average of the respective required times, computing a total required time to resolve all of the deferrable contacts of the second plurality of deferrable contacts; with the GUI: displaying the total required time to the manager computing device; receiving an approval from the manager computing device. The method also includes, with the intraday manager service, automatically generating a required staffing; with the scheduler service, the required staffing and the scheduling rules database, automatically generating an agent schedule; and with the GUI, publishing the agent schedule to the plurality of agent computing devices. Other embodiments of this aspect include corresponding computer systems, apparatus, and computer programs recorded on one or more computer storage devices, each configured to perform the actions of the methods.

Implementations may include one or more of the following features. In some embodiments, the first plurality of deferrable contacts and the second plurality of deferrable contacts are of a plurality of contact types. In some embodiments, the plurality of contact types may include at least two of email contacts, voicemail contacts, social media contacts, or other contacts (e.g., messaging contacts such as SMS, chat, or otherwise). In some embodiments, the respective required time required for each resolution depends on a contact type of the respective deferrable contact, where the average of the respective times may include a separate average for each contact type. In some embodiments, each agent computing device of the plurality of agent computing devices is associated with an agent of the plurality of agents, where the agent schedule may include a separate schedule for each agent of the plurality of agents, and where the separate schedule for each agent is based on a skill of the respective agent with regard to at least one contact type of the plurality of contact types. In some embodiments, displaying the total required time to the manager computing device involves first receiving a manager estimate of the total required time. In some embodiments, displaying the total required time to the manager computing device includes generating and displaying a natural language output related to the total required time. In some embodiments, generating and displaying the natural language output involves: sending a prompt to a large language model (LLM); receiving a natural language output from the LLM; and displaying the natural language output. In some embodiments, the method may include automatically distributing the deferrable contacts of the second plurality of contacts to a plurality of agents via the plurality of agent computing devices. Implementations of the described techniques may include hardware, a method or process, or computer software on a computer-accessible medium.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the deferrable contact staffing forecasting system, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is a schematic, diagrammatic representation, in block diagram form, of a workforce management computing system, in accordance with at least one embodiment of the present disclosure.

FIG. 2 is a schematic, diagrammatic representation, in block diagram form, of a workforce management architecture, in accordance with at least one embodiment of the present disclosure.

FIG. 3 is a schematic, diagrammatic representation, in block diagram form, of an example deferrable contact staffing forecasting system, in accordance with at least one embodiment of the present disclosure.

FIG. 4 is a schematic, diagrammatic representation, in flow hybrid flow diagram/block diagram form, of an example deferrable contact staffing forecasting method, in accordance with at least one embodiment of the present disclosure.

FIG. 5 is a schematic, diagrammatic representation, in hybrid block diagram/flow diagram form, of an example deferrable contact staffing forecasting method, in accordance with at least one embodiment of the present disclosure.

FIG. 6 is a continuation of the hybrid block diagram/flow diagram of FIG. 5, in accordance with at least one embodiment of the present disclosure.

FIG. 7 is a staffing parameters or service targets graphical user interface screen display of an example deferrable contact staffing forecasting system, in accordance with at least one embodiment of the present disclosure.

FIG. 8 is a schematic, diagrammatic representation, in flow diagram form, of an example deferrable contact staffing forecasting method, in accordance with at least one embodiment of the present disclosure.

FIG. 9 is a schematic diagram of a processor circuit, according to embodiments of the present disclosure.

### DETAILED DESCRIPTION

In accordance with at least one embodiment of the present disclosure, a deferrable contact staffing forecasting system is provided which facilitates forecasting and scheduling of agent time to handle pending and expected deferrable contacts. Deferrable contacts are contacts from customers of the contact center seeking assistance, and include email, voice mail, messaging, social media, and other types of asynchronous contacts. Historical data (e.g., data accumulated over one week, one month, etc.) is used to determine the average amount of time required by agents to handle each type of deferred contact. These averages are then used to identify service targets (e.g., allotted agent time) for pending deferrable contacts, and this information is used to prompt the WFM supervisor, to help them make informed decisions confidently on the service level agreements (SLAs) to be entered at the time of generating the staffing requirements, so that the SLAs can be met.

Average times required to address each contact type are calculated from historical data. In some implementations, a standard deviation may be used to eliminate the outliers (e.g., contacts that took a two-sigma or greater amount of time to address) from the averages. These averages can then be used to calculate the estimated hours needed to handle each contact type in the future, based on the historical data for each deferred contact. The historical data can be selected for different time periods, e.g., from inception of the contact center, over a recent past time period (e.g., one week, one month, six months, or a year), over a comparable time period (e.g., during the same month from a year prior or over multiple prior years), or the like.

Service targets such as simultaneous handling of contacts (e.g. the number of email contacts that can be handled simultaneously, the number of voice mail contacts that can be handles simultaneously (independent of the emails), etc.) are set by the WFM supervisor. The averages obtained above are then used to proportionally increase the amount of agent time required for each contact type. For example, if an average of 2 hours is required for handling one email contact, and if the simultaneous handling value is set to 2 by the supervisor for this contact type, then this means that the contact center must have 2 agents on hand to cover email contacts, and the number of necessary agent hours proposed by the system would be 4 for that contact type, meaning that 4 agent hours must be set aside for each 1-2 deferred email contacts.

Depending on the implementation, the system may also cumulatively evaluate the simultaneous handling of all the contact types defined by the WFM supervisor to determine overall business hours required (e.g., the staffing requirement) to handle 100% of the known deferred contacts. This information can inform the supervisor as to whether all of the pending deferred contacts can, for example, be handled within a single business day, calendar day, or single employee shift.

Once the supervisor confirms these service targets, the system defined herein may also automatically generate the agent schedules. This may for example include identifying agents who possess the skill for a given contact type, as well as identifying scheduling rules and agent configuration, along with the computed staffing requirement, and assigning appropriately skilled agents to address the pending deferred contacts. This ensures that the service targets are properly accounted for in the agent schedules.

In some implementations, the system may also forecast demand for deferrable contacts that have not yet arrived in the system, based on historical data about incoming contacts, taking into account weekends, holidays, and other special days (e.g., the day of the week, a sporting event such as the Olympics, playoff game day, or a Superbowl game day, day after a holiday, etc.). This helps to ensure that sufficient staffing exists for the likely demand.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one of ordinary skill in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

The present disclosure aids substantially in the determination of agent staffing levels and schedules, by improving the supervisor's ability to forecast the agent time required to handle deferred contacts. Implemented on a processor in communication with an intraday manager database, the deferrable contact staffing forecasting system disclosed herein provides practical improvements in the workforce management workflow. This improved forecasting ability transforms a process that is reliant on memory, skill, and experience into one that is precise, repeatable, and automatic, without the normally routine need to train WFM supervisors on the details of deferred contact handling. This unconventional approach improves the functioning of the workforce management computer system, by reducing the amount of computer time required to generate realistic agent schedules, thus reducing energy consumption and the greenhouse gas emissions associated therewith.

The deferrable contact staffing forecasting system and methods may be implemented as a process at least partially viewable on a display, and operated by a control process executing on a processor that accepts user inputs from a keyboard, mouse, or touchscreen interface, and that is in communication with one or more databases. In that regard, the control process performs certain specific operations in response to different inputs or selections made at different times. Certain outputs of the deferrable contact staffing forecasting system may be printed, shown on a display, or otherwise communicated to human operators. Certain structures, functions, and operations of the processor, display, sensors, and user input systems are known in the art, while others are recited herein to enable novel features or aspects of the present disclosure with particularity.

These descriptions are provided for exemplary purposes only, and should not be considered to limit the scope of the deferrable contact staffing forecasting system. Certain features may be added, removed, or modified without departing from the spirit of the claimed subject matter.

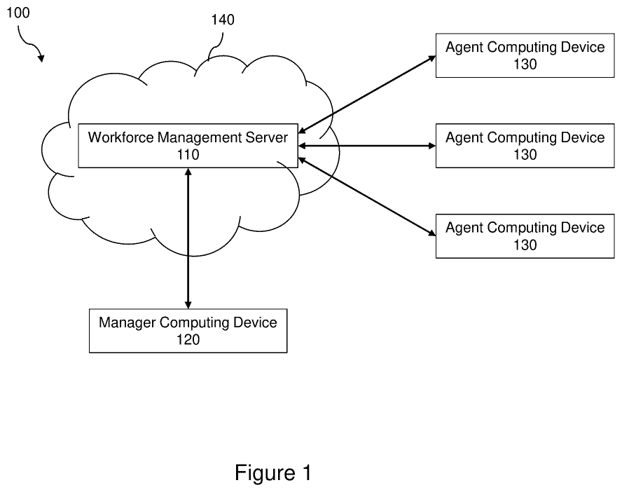

FIG. 1 is a schematic, diagrammatic representation, in block diagram form, of a workforce management computing system 100, in accordance with at least one embodiment of the present disclosure. In the example shown in FIG. 1, the workforce management computing system 100 includes a workforce management server 110 in communication with at least one manager computing device 120, and with multiple agent computing devices 130. The WFM server 110 may for example be a virtual server that operates on a cloud server 140 located in a different physical location than the manager computing device 120 and the agent computing devices 130. However, in some implementations, the WFM server 110 may be a physical server located in the contact center. The manager computing device 120 and the agent computing devices 130 may be located in the contact center. However, in some implementations, the manager computing device 120 and the agent computing devices 130 may be part of a virtual contact center that is distributed across multiple locations.

Before continuing, it should be noted that the examples described above are provided for purposes of illustration, and are not intended to be limiting. Other devices and/or device configurations may be utilized to carry out the operations described herein.

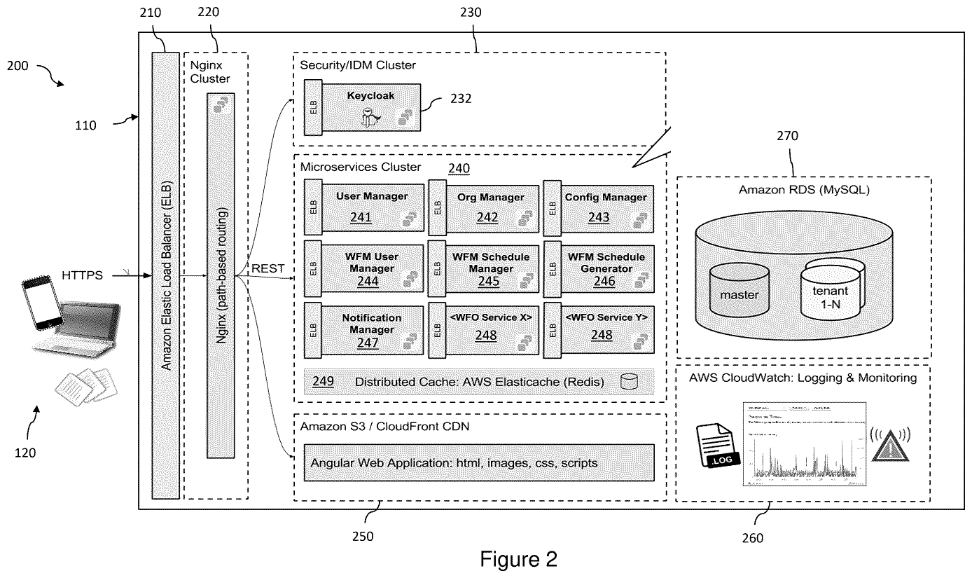

FIG. 2 is a schematic, diagrammatic representation, in block diagram form, of a workforce management architecture 200, in accordance with at least one embodiment of the present disclosure. The WFM architecture 200 includes a manager computing device 120 in communication with a WFM server 110. In the example shown in FIG. 2, the WFM server 110 includes a load balancer 210, a path-based router 220 (e.g., an open-source web server software that can also be used as a reverse proxy, load balancer, email proxy, and HTTP cache), and a security and identity management cluster 230 that includes an identity manager 232 (e.g., an open-source Identity and Access Management (IAM) tool to provide single sign-on (SSO) access to applications and services.). The WFM server 110 also includes a microservices cluster 240 (e.g., Amazon Elastic Container Service (Amazon ECS), a cloud computing service in Amazon Web Services (AWS) that manages containers and allows developers to run applications in the cloud without having to configure an environment for the code to run in). The microservices cluster 240 includes a user manager 241, an organization manager 242, a configuration manager 243, a WFM user manager 244, a WFM schedule manager 245, a WFM schedule generator 246, a notification manager 247, and additional services 248, along with a distributed cache 249.

The WFM server 110 also includes a content delivery network 250 (e.g., Amazon CloudFront, a content delivery network (CDN) service operated by Amazon Web Services and designed to provide a globally distributed network of proxy servers to cache content, such as web videos or other bulky media, more locally to consumers). The WFM server 110 also includes a database manager 270 (e.g., Amazon Relational Database Service (RDS), a web service offered by Amazon Web Services (AWS) that is a managed SQL database service that helps with relational database management tasks, such as data migration, backup, recovery, and patching), and a logging and monitoring service 260 (e.g., AWS CloudWatch, a monitoring and management service for AWS resources and applications that collects, tracks, and displays metrics to measure resources and applications for each service).

It is understood that this description is exemplary, and the WFM server 110 may contain some, all, or none of the listed components (or even additional components), while still performing the functions described herein.

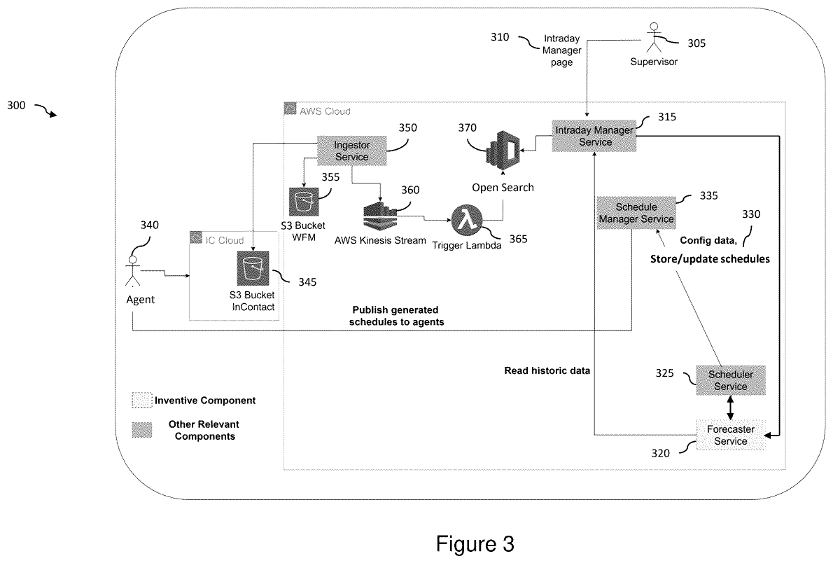

FIG. 3 is a schematic, diagrammatic representation, in block diagram form, of an example deferrable contact staffing forecasting system 300, in accordance with at least one embodiment of the present disclosure. In the example shown in FIG. 3, a WFM supervisor 305 uses an intraday manager page 310 to access an intraday manager service 315, which communicates bidirectionally with a forecaster service 320, which communicates bidirectionally with a scheduler service 325, which provides data 330 to a schedule manager service 335, which generates agent schedules and communicates them to one or more agents 340. The intraday manager service 315 also communicates with an Open Search application 370 (e.g., a managed service that allows users to search, analyze, and monitor large amounts of data).

An ingestor service (e.g., a service for ingesting intraday data) communicates with simple storage services (S3) 345 and 355, and with an Amazon Web Services Kinesis Stream (e.g., a managed streaming data service that is used for data processing from producers and consumers), which communicates with a Trigger Lambda application (e.g., a serverless computing management application), which communicates with the Open Search application 370.

It is understood that the architecture shown is exemplary, and the deferrable contact staffing forecasting system 300 may use different components while still performing the functions described herein.

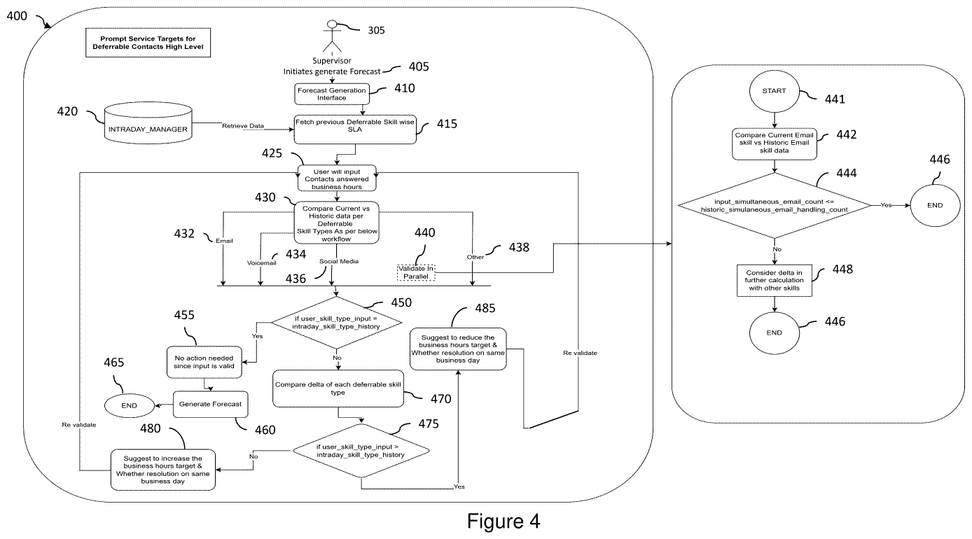

FIG. 4 is a schematic, diagrammatic representation, in flow hybrid flow diagram/block diagram form, of an example deferrable contact staffing forecasting method 400, in accordance with at least one embodiment of the present disclosure. It is understood that the steps of method 400 may be performed in a different order than shown in FIG. 4, additional steps can be provided before, during, and after the steps, and/or some of the steps described can be replaced or eliminated in other embodiments. One or more of steps of the method 400 can be carried by one or more devices and/or systems described herein, such as components of system 100, system 300, and/or processor circuit 950.

In step 405, the method 400 includes receiving an input from the supervisor 305 via the forecast generation graphical user interface 410 initiating a deferrable contact staffing forecast. Execution then proceeds to step 415.

In step 415, the method 400 includes fetching the previous service level agreement (SLA) for deferrable contacts and associated agent skills from the Intraday Manager database 420. Execution then proceeds to step 425.

In step 425, the method 400 includes receiving a user input from the supervisor 305, via the forecast generation graphical user interface 410, regarding the number of business hours anticipated to be needed to answer pending and expected deferrable contacts. Execution then proceeds to step 430.

In step 430, the method 400 includes comparing the user input number of hours vs. historic data for different skill types, including email contacts 432, voicemail contacts 434, social media contacts 436, and “other” contacts 438 (e.g., postal mail, chat messages, callback requests, or feedback on surveys). Execution then proceeds to steps 440 and 450.

In step 440, the method 400 includes initiating a parallel validation process that begins at step 441. Execution then proceeds to step 442.

In step 442, the method 400 includes comparing the current email skill allocations vs. historic email skill data. Execution then proceeds to step 444.

In step 444, the method 400 includes determining whether the simultaneous handling count for email contacts, inputted by the supervisor 305, is less than or equal to the historic simultaneous handling count for email contacts. If yes, execution proceeds to step 446. If no, execution proceeds to step 448.

In step 446, the parallel validation process is complete.

In step 448, the method 400 includes considering a delta in further calculation with other skills. This is similar to the comparison for email in steps 442 and 444, repeated for other skills such as Social Media, etc., in parallel. Execution then proceeds to step 446.

The parallel validation steps 441-448 are then repeated for each deferred contact type.

In step 450, the method 400 includes determining whether the user skill type input, in business hours, is equal to the intraday skill type history for that skill type (e.g., for that deferrable contact type). If yes, execution then proceeds to step 455. If no, execution proceeds to step 470.

In step 455, no adjustment is needed, since the supervisor's input value is consistent with historical values. Execution then proceeds to step 460.

In step 460, the method 400 includes generating the staffing forecast to handle pending and expected deferrable contacts. Execution then proceeds to step 465.

In step 465, the method 400 is complete.

In step 470, the method 400 includes comparing the delta (in business hours) between the user input and the historical value for each skill type (e.g., each deferrable contact type). Execution then proceeds to step 475.

In step 475, the method includes determining whether the user skill type input for each skill type (e.g., each deferrable contact type) is greater than the historical value for that skill type. If yes, execution proceeds to step 485. If no, execution proceeds to step 480.

In step 480, the method 400 includes generating an output to the user, via the GUI, suggesting an increase in the business hours target, and inquiring whether resolution of all deferrable contacts is desired on the same business day (e.g., whether some contacts may be addressed on the following business day). Execution then returns to step 425.

In step 485, the method 400 includes generating an output to the user, via the GUI, suggesting a decrease in the business hours target, and inquiring whether resolution of all deferrable contacts is desired on the same business day (e.g., whether some contacts may be addressed on the following business day). Execution then returns to step 425.

Steps 425 through 485 may occur iteratively until the user (e.g., the supervisor) has entered a value equal to the historical value, or within a threshold distance of the historical value.

Flow diagrams and block diagrams are provided herein for exemplary purposes; a person of ordinary skill in the art will recognize myriad variations that nonetheless fall within the scope of the present disclosure. For example, any of the steps described herein may optionally include an output to a user of information relevant to the step, and may thus represent an improvement in the user interface over existing art by providing information (whether static or dynamically updated) that is not otherwise available.

Similarly, block diagrams may show a particular arrangement of components, modules, services, steps, processes, or layers, resulting in a particular data flow. It is understood that some embodiments of the systems disclosed herein may include additional components, that some components shown may be absent from some embodiments, and that the arrangement of components may be different than shown, resulting in different data flows while still performing the methods described herein.

Similarly, the logic of flow diagrams may be shown as sequential. However, similar logic could be parallel, massively parallel, object oriented, real-time, event-driven, cellular automaton, or otherwise, while accomplishing the same or similar functions. In order to perform the methods described herein, a processor may divide each of the steps described herein into a plurality of machine instructions, and may execute these instructions at the rate of several hundred, several thousand, several million, or several billion per second (or more), in a single processor or across a plurality of processors. Such rapid execution may be necessary in order to execute the method in real time or near-real time as described herein.

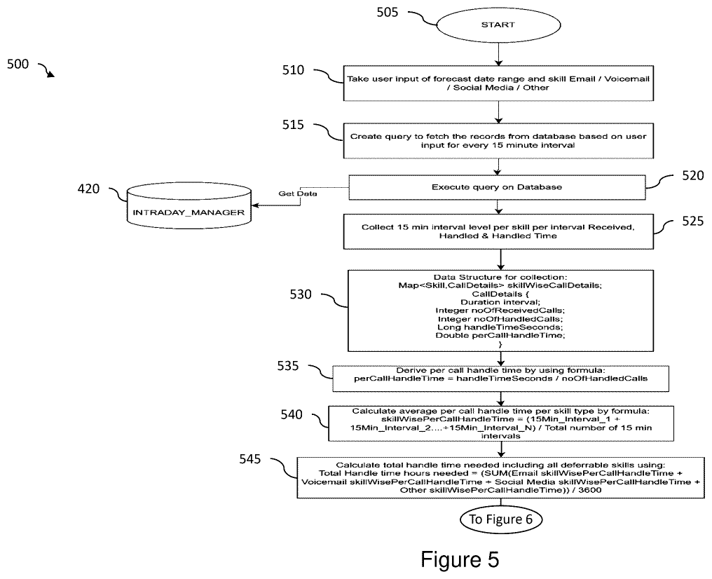

FIG. 5 is a schematic, diagrammatic representation, in hybrid block diagram/flow diagram form, of an example deferrable contact staffing forecasting method 500, in accordance with at least one embodiment of the present disclosure.

In step 505, the method 500 begins. Execution then proceeds to step 510.

In step 510, the method 500 includes receiving a user input of the estimated business hours required to address deferred contacts of each type (e.g., email, voicemail, social media, and other) for a given date range (often a single business day). Execution then proceeds to step 515.

In step 515, the method 500 includes creating a database query to fetch records from the Intraday Manager database 420, based on the user input, for each 15-minute interval of a historical period (e.g., the past month). Execution then proceeds to step 520.

In step 520, the method 500 includes executing the query on the database 420. Execution then proceeds to step 525.

In step 525, the method 500 includes collecting the 15-minute-interval-level data per skill (e.g., per deferrable contact type), where the data includes contacts received, contacts handled (e.g., addressed or completed), and the time required to handle each contact, and where the data may conform to an example data structure 530. Execution then proceeds to step 535.

In step 535, the method 500 includes deriving the per-call handle time, using the formula: perCallHandleTime—handleTimeSeconds/noOfHandledCalls. In other words, the per call handle time is the total time spent handling calls, divided by the total number of calls handled. Execution then proceeds to step 540.

In step 540, the method 500 includes calculating the average per skill type or contact type by adding the time spent handling calls of that skill type or contact type, according to the formula: skillWisePerCallHandleTime=(15Min_Interval_1+15Min_Interval_2 . . . +15Min_Interval_N)/Total number of 15 minute intervals. Execution then proceeds to step 545.

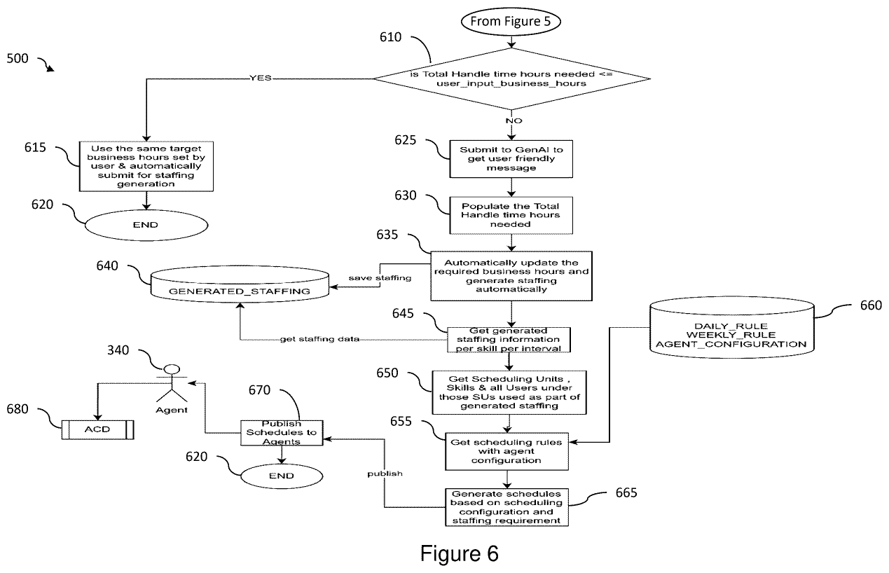

In step 545, the method 500 includes calculating the total handle time needed including all deferrable skills using the formula: Total handle time hours needed=(SUM(Email skillWisePerCallHandleTime+Voicemail skillWisePerCallHandleTime+Social Media skillWisePerCallHandleTime+Other skillWisePerCallHandleTime)/3600. Execution then proceeds to FIG. 6, step 610.

FIG. 6 is a continuation of the hybrid block diagram/flow diagram of FIG. 5, in accordance with at least one embodiment of the present disclosure.

In step 610, the method 500 includes determining whether the total handle time hours needed is less than or equal to the number of hours input by the user. If yes, execution proceeds to step 615. If no, execution proceeds to step 625.

In step 615, the method 500 includes using the business hours target(s) set by the user and automatically submitting them for staffing generation. Execution then proceeds to step 620.

In step 620, the method 500 is complete.

In step 625, the method 500 includes submitting the total hours shortfall to a generative AI (GenAI) model, to obtain a user-friendly, natural-language message, informing the user of the shortfall. Execution then proceeds to step 630.

In step 630, the method 500 includes populating the total handle time hours needed, in order to handle all of the pending and expected deferrable contacts of all types. Execution then proceeds to step 635.

In step 635, the method 500 includes automatically updating the required business hours and automatically generating the staffing, which may for example be saved in a generated staffing database 640. Execution then proceeds to step 645.

In step 645, the method 500 includes fetching the generated staffing information, per skill type and per 15-minute interval, from the generated staffing database 640. Execution then proceeds to step 650.

In step 650, the method 500 includes fetching the scheduling rules, with agent configuration, from a rules and configurations database 660. Execution then proceeds to step 665.

In step 665, the method 500 includes generating agent schedules based on the scheduling rules, the agent configuration, and the staffing requirement. Execution then proceeds to step 670.

In step 670, the method 500 includes publishing the generated schedules to one or more agents 340. Execution then proceeds to step 620.

Once the schedules are published, the agents 340 may receive and handle the deferred contacts via an automated call distribution (ACD) system 680.

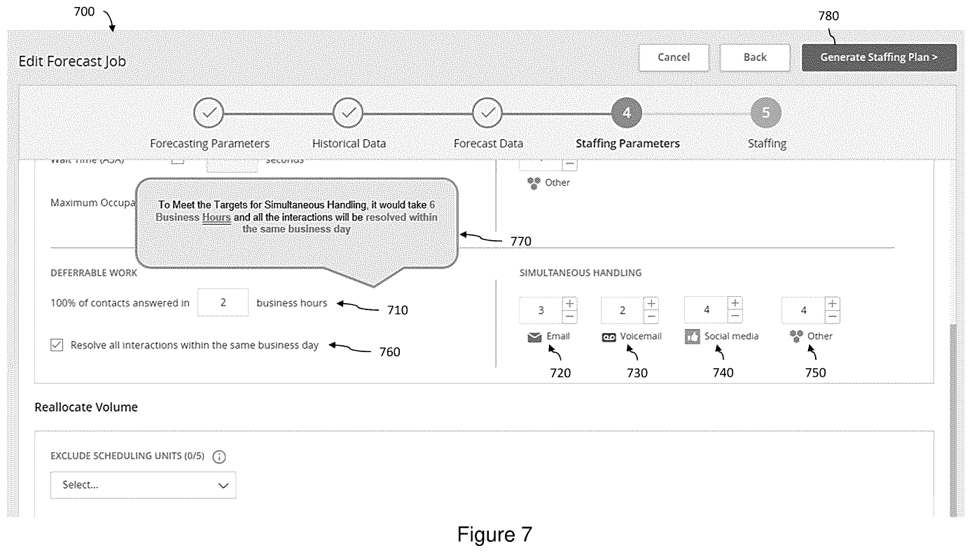

FIG. 7 is a staffing parameters or service targets graphical user interface screen display 700 of an example deferrable contact staffing forecasting system, in accordance with at least one embodiment of the present disclosure. In the example shown in FIG. 7, the screen display 700 includes staffing target inputs such as a deferrable work estimated business hours input box 710, an email simultaneous handling input box 720, a voicemail simultaneous handling input box 730, a social media simultaneous handling input box 740, and an “other” simultaneous handling input box 750. Simultaneous handling reflects the number of contacts of that type that agents are expected to be able to work on in parallel. In the example shown in FIG. 7, agents are projected to handle 3 simultaneous email contacts, 2 simultaneous voicemail contacts, 4 simultaneous social media contacts, and 4 simultaneous “other” contacts. This may for example require a total of at least 3+2+4+4=13 agents dedicated to handling deferrable contacts. The screen display 700 also includes a check box 760 indicating whether all deferrable contacts are required to be handled in the same business day.

In the example shown in FIG. 7, the user (e.g., a staffing supervisor) has underestimated the total number of business hours required to answer 100% of the deferrable contacts. Specifically, the user has entered an estimated value of 2 business hours into the input box 710, whereas in fact a total of 6 business hours are required to address all of the pending and expected deferrable contacts within the same business day. Thus, the deferrable contact staffing forecasting system has generated a natural-language pop-up message 770, informing the user of the discrepancy. The user then has the option (though not the requirement) to update the estimated hours in the deferrable work estimated business hours input box 710. Notably, because the system operates continuously in real time, the pop-up message 770 is dynamic; if the user enters another incorrect value or new deferrable contacts are received by the system, the pop-up message will dynamically update with a new natural-language message.

The screen display 700 also includes a “generate staffing plan” button 780 that the user (e.g., the supervisor) can use to approve the staffing parameters and implement a staffing plan based on the service targets entered in boxes 710-760. In some implementations, the staffing plan may be generated automatically, without user input, each time a service target is updated or a new deferrable contact is received.

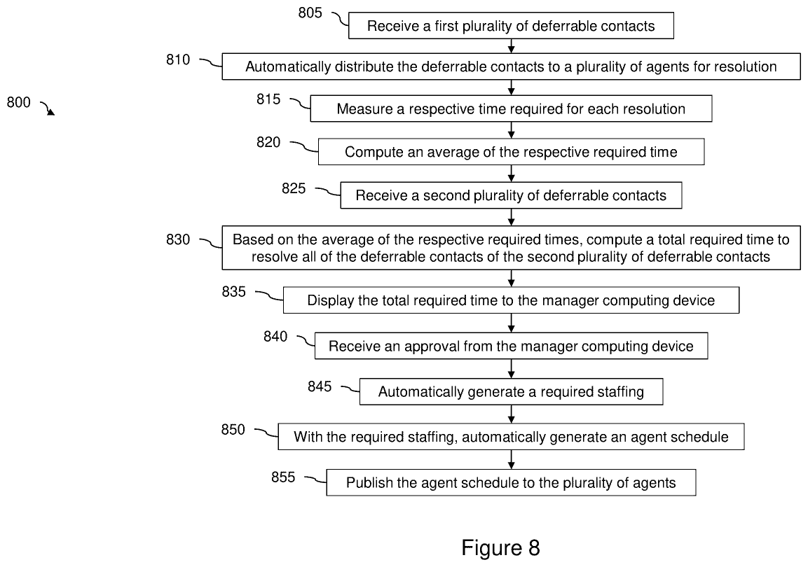

FIG. 8 is a schematic, diagrammatic representation, in flow diagram form, of an example deferrable contact staffing forecasting method 800, in accordance with at least one embodiment of the present disclosure.

In step 805, the method 800 includes receiving a first plurality of deferrable contacts. Execution then proceeds to step 810.

In step 810, the method 800 includes automatically distributing the deferrable contacts to a plurality of agents for resolution. This may for example occur over a period of time such as one week, one month, etc. Execution then proceeds to step 815.

In step 815, the method 800 includes measuring the times required for the agents to resolve each deferrable contact. Execution then proceeds to step 820.

In step 820, the method 800 includes computing an average of the required times required for the agents to resolve each deferrable contact over the period of time during which they were measured (e.g., the past week, the past month, etc.). This average then represents the expected or anticipated time required for an agent to resolve a contact of that type. Execution then proceeds to step 825.

In step 825, the method 800 includes receiving a second plurality of deferrable contacts. Execution then proceeds to step 830.

In step 830, the method 800 includes, based on the average of the required times required for the agents to resolve each deferrable contact, computing a total time required to resolve all of the deferrable contacts of the second plurality of deferrable contacts. Execution then proceeds to step 835.

In step 835, the method 800 includes displaying, to the manager computing device, the total time required. Execution then proceeds to step 840.

In step 840, the method 800 includes receiving an approval from the manager computing device. This may for example take the form of the user (e.g., the manager or supervisor) updating service targets to match the total time required, and then clicking a “generate staffing plan” button. Execution then proceeds to step 845.

In step 845, the method 800 includes automatically generating the required staffing to meet the specified service targets. Execution then proceeds to step 850.

In step 850, the method 800 includes, with the required staffing, generating one or more agent schedules to meet the service targets. Execution then proceeds to step 855.

In step 855, the method 800 includes publishing the schedule(s) to the plurality of agents. The method 800 is now complete.

In some implementations, steps 825-835 may be performed continuously in real time, with the total time requirement being continuously updated as new service targets are entered or new deferrable contacts are received. In some implementations, steps 825-855 may be performed continuously in real time, with the required staffing, and possibly the agent schedules, updating in real time as new service targets are entered or new deferrable contacts are received. Steps 805-855 may be performed for deferrable contacts of any single type, or may be performed for contacts of multiple types.

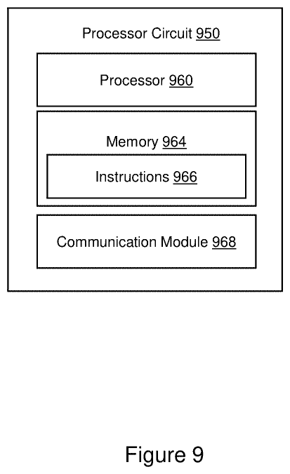

FIG. 9 is a schematic diagram of a processor circuit 950, according to embodiments of the present disclosure. The processor circuit 950 may be implemented in the system 100, the system 300, or other devices or workstations (e.g., third-party workstations, network routers, etc.), or on a cloud processor or other remote processing unit, as necessary to implement the method. As shown, the processor circuit 950 may include a processor 960, a memory 964, and a communication module 968. These elements may be in direct or indirect communication with each other, for example via one or more buses.

The processor 960 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 960 may also comprise another hardware device, a firmware device, or any combination thereof configured to perform the operations described herein. The processor 960 may also be implemented as a combination of computing devices, e.g., a combination of a DSP and a microprocessor, a plurality of microprocessors, one or more microprocessors in conjunction with a DSP core, or any other such configuration.

The memory 964 may include a cache memory (e.g., a cache memory of the processor 960), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 964 includes a non-transitory computer-readable medium. The memory 964 may store instructions 966. The instructions 966 may include instructions that, when executed by the processor 960, cause the processor 960 to perform the operations described herein. Instructions 966 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 968 can include any electronic circuitry and/or logic circuitry to facilitate direct or indirect communication of data between the processor circuit 950, and other processors or devices. In that regard, the communication module 968 can be an input/output (I/O) device. In some instances, the communication module 968 facilitates direct or indirect communication between various elements of the processor circuit 950 and/or the system 100 or 300. The communication module 968 may communicate within the processor circuit 950 through numerous methods or protocols. Serial communication protocols may include but are not limited to United States Serial Protocol Interface (US SPI), Inter-Integrated Circuit (I²C), Recommended Standard 232 (RS-232), RS-485, Controller Area Network (CAN), Ethernet, Aeronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial and parallel communications may be bridged by a Universal Asynchronous Receiver Transmitter (UART), Universal Synchronous Receiver Transmitter (USART), or other appropriate subsystem.

External communication (including but not limited to software updates, firmware updates, preset sharing between the processor and central server, or readings from one or more databases) may be accomplished using any suitable wireless or wired communication technology, such as a cable interface such as a universal serial bus (USB), micro USB, Lightning, or FireWire interface, Bluetooth, Wi-Fi, ZigBee, Li-Fi, or cellular data connections such as 2G/GSM (global system for mobiles), 3G/UMTS (universal mobile telecommunications system), 4G, long term evolution (LTE), WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

As will be readily appreciated by those having ordinary skill in the art after becoming familiar with the teachings herein, the deferrable contact staffing forecasting system fills a long-standing need in the art, by dynamically alerting the manager or supervisor when current service targets are insufficient to meet the expected demand for agent hours to address deferrable contacts.

A number of variations are possible on the examples and embodiments described above. For example, any of the computing devices described herein could be cloud-based, virtual, mainframe, desktop, laptop, notebook, or smartphone type computers, or otherwise, without departing from the spirit of the present disclosure. The number and types of deferrable contacts may be different than described herein. The technology described herein may be used to manage deferrable contacts in a variety of contact settings, including but not limited to contact centers for customer service, technical support, information, first responders, etc.

Accordingly, the logical operations making up the embodiments of the technology described herein are referred to variously as operations, steps, objects, elements, components, or modules. Furthermore, it should be understood that these may occur, or be performed or arranged, in any order, unless explicitly claimed otherwise or a specific order is inherently necessitated by the claim language.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the deferrable contact staffing forecasting system. Connection references, e.g., attached, coupled, connected, joined, or “in communication with” are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting.

The above specification, examples and data provide a complete description of the structure and use of exemplary embodiments of the deferrable contact staffing forecasting system as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A system adapted to automatically manage deferrable contacts in a contact center, the system comprising:
a workforce management server having a processor and a non-transitory computer readable medium operably coupled thereto, the server being in electronic communication with a manager computing device and a plurality of agent computing devices, the processor comprising: an intraday manager service, a scheduler service, a forecaster service, and a graphical user interface (GUI), the server being in electronic communication with an intraday manager database, the computer readable medium comprising a plurality of instructions stored in association therewith that are accessible to, and executable by, the processor, to perform operations which comprise:
with the workforce management server, over a first period of time:
receiving a first plurality of deferrable contacts;
automatically distributing the deferrable contacts of the first plurality of deferrable contacts to a plurality of agents for resolution via the plurality of agent computing devices;
measuring a respective time required for each resolution;
computing an average of the respective required times;
continuously, in real time, with the workforce management server:
receiving a second plurality of deferrable contacts;
based on the average of the respective required times, computing a total required time to resolve all of the deferrable contacts of the second plurality of deferrable contacts;
with the GUI:
displaying the total required time to the manager computing device;
receiving an approval from the manager computing device;
with the intraday manager service, automatically generating a required staffing;
with the scheduler service, the required staffing and the scheduling rules database, automatically generating an agent schedule; and
with the GUI, publishing the agent schedule to the plurality of agent computing devices.

2. The system of claim 1, wherein the first plurality of deferrable contacts and the second plurality of deferrable contacts are of a plurality of contact types.

3. The system of claim 2, wherein the plurality of contact types comprises at least two of email contacts, voicemail contacts, social media contacts, or other contacts.

4. The system of claim 2, wherein the respective required time for each resolution depends on a contact type of the respective deferrable contact,
wherein the average of the respective times comprises a separate average for each contact type.

5. The system of claim 2, wherein each agent computing device of the plurality of agent computing devices is associated with an agent of the plurality of agents,
wherein the agent schedule comprises a separate schedule for each agent of the plurality of agents, and
wherein the separate schedule for each agent is based on a skill of the respective agent with regard to at least one contact type of the plurality of contact types.

6. The system of claim 1, wherein displaying the total required time to the manager computing device involves first receiving a manager estimate of the total required time.

7. The system of claim 1, wherein displaying the total required time to the manager computing device includes generating and displaying a natural language output related to the total required time.

8. The system of claim 7, wherein generating and displaying the natural language output involves:
sending a prompt to a large language model (LLM);
receiving a natural language output from the LLM; and
displaying the natural language output.

9. The system of claim 1, wherein the instructions further comprise automatically distributing the deferrable contacts of the second plurality of contacts to the plurality of agents for resolution via the plurality of agent computing devices.

10. A method to manage deferrable contacts in a contact center, the method comprising:
with a workforce management server having a processor and a non-transitory computer readable medium operably coupled thereto, the server being in electronic communication with a manager computing device and a plurality of agent computing devices, the processor comprising an intraday manager service, a scheduler service, a forecaster service, and a graphical user interface (GUI), the server being in electronic communication with a scheduling rules database, the computer readable medium comprising a plurality of instructions stored in association therewith that are accessible to, and executable by, the processor, performing operations which comprise:
with the workforce management server, over a first period of time:
receiving a first plurality of deferrable contacts;
automatically distributing the deferrable contacts of the first plurality of deferrable contacts to a plurality of agents for resolution via the plurality of agent computing devices;
measuring a respective time required for each resolution;
computing an average of the respective required times;
continuously, in real time, with the workforce management server:
receiving a second plurality of deferrable contacts;
based on the average of the respective required times, computing a total required time to resolve all of the deferrable contacts of the second plurality of deferrable contacts;
with the GUI:
displaying the total required time to the manager computing device;
receiving an approval from the manager computing device;
with the intraday manager service, automatically generating a required staffing;
with the scheduler service, the required staffing and the scheduling rules database, automatically generating an agent schedule; and
with the GUI, publishing the agent schedule to the plurality of agent computing devices.

11. The method of claim 10, wherein the first plurality of deferrable contacts and the second plurality of deferrable contacts are of a plurality of contact types.

12. The method of claim 11, wherein the plurality of contact types comprises at least two of email contacts, voicemail contacts, social media contacts, or other contacts.

13. The method of claim 11, wherein the respective required time required for each resolution depends on a contact type of the respective deferrable contact,
wherein the average of the respective times comprises a separate average for each contact type.

14. The method of claim 11, wherein each agent computing device of the plurality of agent computing devices is associated with an agent of the plurality of agents,
wherein the agent schedule comprises a separate schedule for each agent of the plurality of agents, and
wherein the separate schedule for each agent is based on a skill of the respective agent with regard to at least one contact type of the plurality of contact types.

15. The method of claim 10, wherein displaying the total required time to the manager computing device involves first receiving a manager estimate of the total required time.

16. The method of claim 10, wherein displaying the total required time to the manager computing device includes generating and displaying a natural language output related to the total required time.

17. The method of claim 16, wherein generating and displaying the natural language output involves:
sending a prompt to a large language model (LLM);
receiving a natural language output from the LLM; and
displaying the natural language output.

18. The method of claim 17, further comprising automatically distributing the deferrable contacts of the second plurality of contacts to a plurality of agents via the plurality of agent computing devices.
